(19) United States
(12) Patent Application Publication
(10) Pub. No.: US 2026/0328053 A1
(43) Pub. Date: Oct. 22, 2026

(54) Roller Tube Assemblies

(71) Applicant: Alwood LLC, Richardson, TX (US)

(72) Inventors: Ryan D. Fitzgerald, Doonan (AU); Jason Erickson, Wylie, TX (US); David Cheetham, Garland, TX (US)

(21) Appl. No.: 19/652,174

(22) Filed: Apr. 20, 2026

Related U.S. Application Data
(60) Provisional application No. 63/791,849, filed on Apr. 21, 2025.

(51) Int. Cl. E06B 9/44

(52) U.S. Cl. CPC E06B 9/44

(57) ABSTRACT

A roller tube assembly that is configured to raise and lower a covering to conceal and expose a window, a door, or the like. The roller tube assembly includes an outer tube that is connected to the covering such that rotation of the outer tube causes extension and retraction of the covering as well as a pair of drive reel assemblies that extend into the outer tube. The outer tube includes an outer wall that extends continuously about a circumference thereof and which defines a single internal passage, and the drive reel assemblies include: drive tubes that engage a motor and an idler; drive reels that receive the drive tubes and engage the outer tube; and mounting plates that are connected to the drive reels.

### CROSS-REFERENCE TO RELATED APPLICATIONS

This application claims the benefit of and priority to U.S. Provisional Patent Application Serial No. 63/791,849, filed on Apr. 21, 2025, the entire content of which is hereby incorporated by reference.

### TECHNICAL FIELD

The present disclosure relates to lightweight roller tube assemblies for screens, shutters, and the like that are configured to inhibit (e.g., prevent) deflection in order to improve operability and reliability.

### BACKGROUND

Roller tube assemblies are used to raise and lower screens, shutters, and the like in homes and commercial spaces in order to cover and expose windows, doors, etc. Typically, roller tube assemblies include an outer tube and a pair of drive reel assemblies that extend into the outer tube. Known roller tube assemblies, however, are difficult to manufacture and are often subject to deflection (e.g., sagging) due to excessive weight which can result in operational issues that require service, maintenance, and/or replacement. For example, FIG. 1 illustrates an outer tube 10 in a known roller tube assembly that includes a discontinuous outer wall 12 with a plurality of recesses 14 and a receptacle 16 that is supported (suspended) within the outer tube 10 by a web that includes struts 18. The receptacle 16 and the web extend continuously between the ends of the outer tube 10 so as to define a plurality of enclosed internal passages 20.

The inclusion of the recesses 14 not only increases the manufacturing complexity of the outer tube 10 but reduces the overall strength thereof, and the inclusion of the receptacle 16, the web, and the struts 18 adds significant weight to the outer tube 10, each of which can contribute to the aforementioned deflection.

The present disclosure addresses these deficiencies by providing a lightweight roller tube assembly that inhibits (e.g., prevents) deflection, thereby improving the operability and the reliability of the roller tube assembly.

### SUMMARY

The present disclosure describes a roller tube assembly that is configured to raise and lower a covering to conceal and expose a window, a door, or the like. The roller tube assembly includes: an outer tube; a first drive reel assembly that is connected to a first end of the outer tube such that rotation of the first drive reel assembly (e.g., via a motor) causes rotation of the outer tube; and a second drive reel assembly that is connected to a second end of the outer tube.

The outer tube includes an outer wall that defines a single internal passage and extends continuously about a circumference of the outer tube. The outer wall is (indirectly) connected to the covering such that rotation of the outer tube causes extension and retraction of the covering.

### BRIEF DESCRIPTION OF THE DRAWINGS

According to common practice, certain components, elements, and/or features may be omitted from certain drawings in the interest of clarity.

FIG. 1 is a cross-sectional view of an outer tube in a known roller tube assembly.

FIG. 2 is a top, perspective view of a roller tube assembly which includes an outer tube and a pair of drive reel assemblies according to the principles of the present disclosure.

FIG. 3 is a top, perspective view of the outer tube and the drive reel assemblies.

FIG. 4 is a top, perspective view of the drive reel assemblies shown separated from the outer tube, each of which includes a drive tube; a drive reel; and a mounting plate.

FIG. 5 is an enlargement of the area of detail identified in FIG. 3.

FIG. 6 is a cross-sectional view of the outer tube.

FIG. 7 is an enlargement of the area of detail identified in FIG. 6.

FIG. 8 is a cross-sectional view taken along line 8-8 in FIG. 5.

FIG. 9 is an end view of a key that is configured for insertion into the outer tube to connect the covering and the outer tube.

FIG. 10 is a top, perspective view of one of the drive reel assemblies shown separated from the outer tube.

FIG. 11 is an enlargement of the area of detail identified in FIG. 4.

FIG. 12 is a top, perspective view of one of the drive reel assemblies shown with parts separated.

FIG. 13 is a cross-sectional view taken along line 13-13 in FIG. 12.

FIG. 14 is an end, perspective view of one of the mounting plates.

FIG. 15 is a top, perspective view of an alternate embodiment of the roller tube assembly which includes a pair of extensions.

FIG. 16 is a top, perspective view of the roller tube assembly seen in FIG. 15 shown with the extensions removed.

FIG. 17 is an enlargement of the area of detail identified in FIG. 15.

FIG. 18 is a partial, top, perspective view of the roller tube assembly seen in FIG. 15 with one of the drive reel assemblies and one of the extensions shown separated from the outer tube.

### DETAILED DESCRIPTION

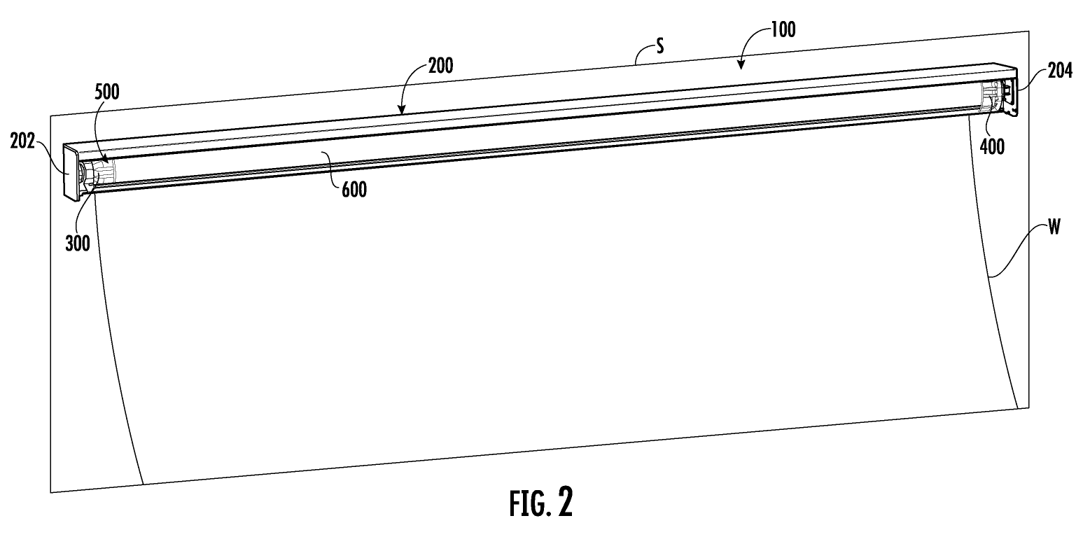

With reference to FIGS. 2-4, a roller tube assembly 100 is illustrated that is configured for use with a window or a door W. The roller tube assembly 100 includes: a mounting member 200 (e.g., a case); a motor 300; an idler 400; an outer tube 500 (which may be referred to as a roll tube); a covering 600 (e.g., a screen, a shade, a shutter, etc.) which is connected to the outer tube 500; and a pair of drive reel assemblies 700. More specifically, the drive reel assemblies 700 include a drive reel assembly 700i (which may be referred to as a first drive reel assembly) and a drive reel assembly 700ii (which may be referred to as a second drive reel assembly). As described in further detail below, the roller tube assembly 100 is configured to raise and lower the covering 600 during use and operation to thereby expose and conceal the window or the door W.

Although generally shown and described in connection with the window or the door W, it should be appreciated that the roller tube assembly 100 may be configured and adapted for use with any functional or design feature or article that would benefit from selective exposure.

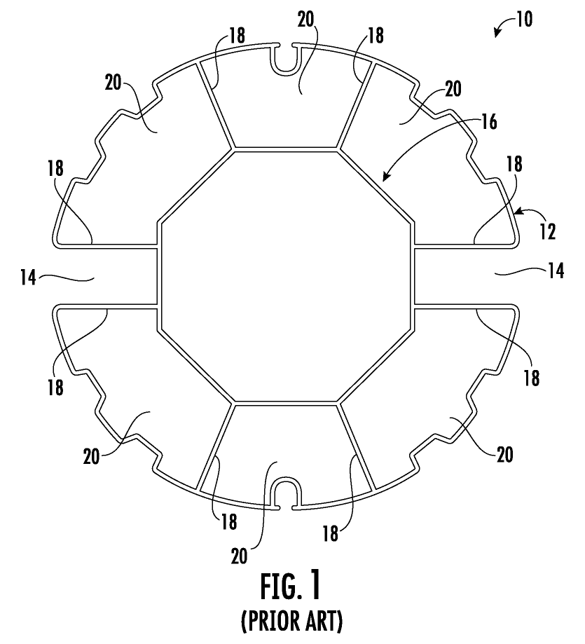

The mounting member 200 includes an end 202 (which may be referred to as a first end) and an end 204 (which may be referred to as a second end). The mounting member 200 is configured for connection to a mounting surface S (FIG. 1) at an installation site on or about (e.g., adjacent to or above) the window or the door W and supports the remaining components of the roller tube assembly 100 (e.g., the motor 300, the idler 400, the outer tube 500, the covering 600, and the drive reel assemblies 700) either directly or indirectly.

The motor 300 is the main drive component of the roller tube assembly 100 and is supported by (e.g., is connected (secured) to) the end 202 or the end 204 of the mounting member 200. The motor 300 engages (is connected (secured) to) the drive reel assembly 700i such, upon actuation, the motor 300 rotates the drive reel assembly 700i and, thus, the outer tube 500, in order to raise and lower the covering 600, as described in further detail below. More specifically, upon actuation, rotation of the motor 300 (and the outer tube 500) in a first direction (e.g., clockwise) causes extension (e.g., lowering) of the covering 600 to cover the window or the door W, and rotation of the motor 300 (and the outer tube 500) in a second direction (e.g., counterclockwise) causes retraction (e.g., raising) of the covering 600 to expose the window or the door W.

The idler 400 is supported by (e.g., is connected (secured) to) the mounting member 200 opposite to the motor 300 at the end 202 or the end 204. The idler 400 engages (is connected (secured) to) the drive reel assembly 700ii and facilitates the rotation thereof during operation of the roller tube assembly 100.

With reference now to FIGS. 5-14 as well, the outer tube 500 and the drive reel assemblies 700 will be discussed.

The outer tube 500 includes a metallic material (e.g., aluminum) and, in the illustrated embodiment, is formed via extrusion. Alternate materials of construction and alternate methods of manufacturing the outer tube 500 are also envisioned herein, however (e.g., depending upon the size of the roller tube assembly 100, the specific configuration and/or the material used in fabrication of the covering 600, the requirements of the particular installation, etc.).

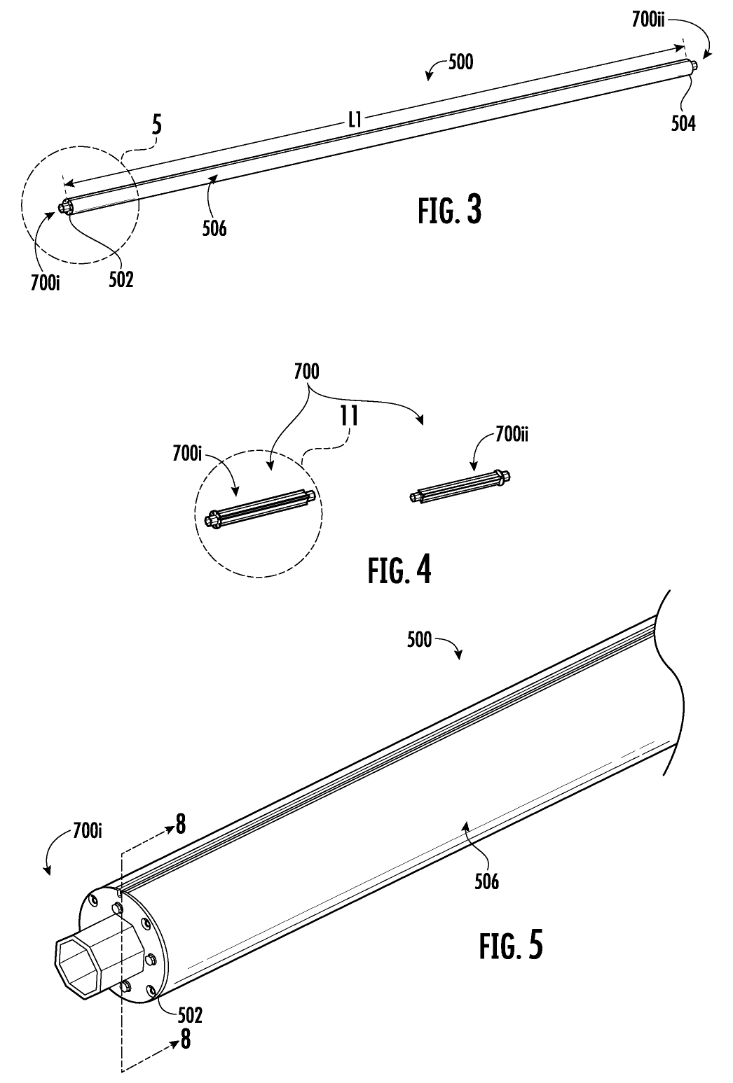

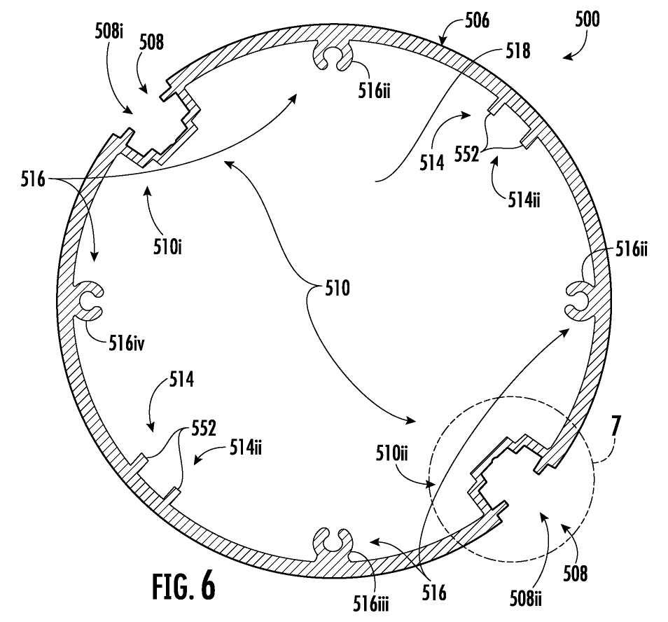

The outer tube 500 defines a length L1 (FIG. 3) (which may be referred to as a first length) and is cut to length (e.g., prior to or during the installation of the roller tube assembly 100) such that the outer tube 500 spans the window or the door W (FIG. 2). The outer tube 500 includes: an end 502 (which may be referred to as a first end) that receives the drive reel assembly 700i; an end 504 (which may be referred to as a second end) that receives the drive reel assembly 700ii; an outer wall 506; reliefs 508 (FIG. 6); alignment members 510 (which may be referred to as first alignment members); keys 512; alignment members 514 (which may be referred to as second alignment members); and flutes 516. The outer tube 500 is uniform in configuration between the ends 502, 504, which reduces manufacturing complexity and, thus, the overall cost of the roller tube assembly 100.

The outer tube 500 (e.g., the outer wall 506) is connected to the drive reel assemblies 700 such that rotation of the drive reel assembly 700i (e.g., via the motor 300) causes corresponding (e.g., concomitant) rotation of the outer tube 500 and the drive reel assembly 700ii (e.g., such that the outer tube 500 and the drive reel assemblies 700 rotate in unison), as described in further detail below. In contrast to the outer tube 10 (FIG. 1) in a known roller tube assembly, in which the outer wall 12 includes a discontinuous configuration with a periphery (e.g., a circumference) that is interrupted by the recesses 14, the outer wall 506 extends continuously about the periphery (e.g., the circumference) of the outer tube 500. As seen in FIG. 6, the outer wall 506 defines a generally annular (e.g., circular) cross-sectional configuration and a single internal passage 518, each of which extends continuously and uniformly between the ends 502, 504 of the outer tube 500, rather than the plurality of enclosed internal passages 20 (FIG. 1) defined by the outer wall 12 of the outer tube 10.

The reliefs 508 are formed in the outer wall 506 and extend continuously between the ends 502, 504 of the outer tube 500. The reliefs 508 extend radially inward into the internal passage 518 and are configured to receive the keys 512, as described in further detail below.

In the illustrated embodiment, the outer tube 500 includes a pair of reliefs 508. More specifically, the outer tube 500 includes a relief 508i (FIG. 6) (which may be referred to as a first relief) and a relief 508ii (which may be referred to as a second relief) that are separated by approximately 180 degrees. Embodiments in which the number of the reliefs 508 and/or the positioning thereof may be varied are also envisioned herein, however (e.g., depending upon the size of the roller tube assembly 100, the specific configuration and/or the material used in fabrication of the covering 600, the requirements of the particular installation, etc.).

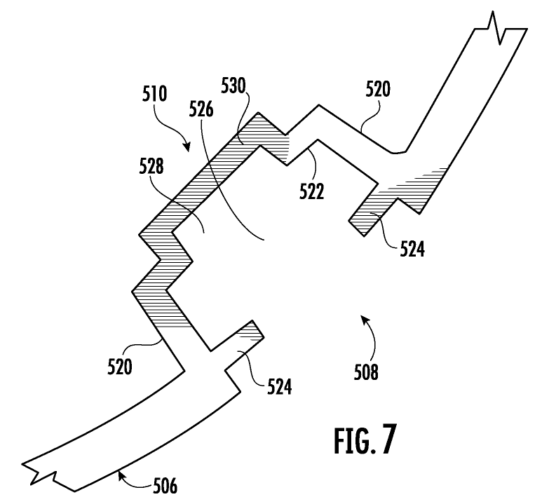

The reliefs 508 include: sidewalls 520 (FIG. 7) that extend radially inward from the outer wall 506 (e.g., in generally orthogonal (perpendicular) relation thereto); base walls 522 (which may be referred to as inner walls or bottom walls); and teeth 524.

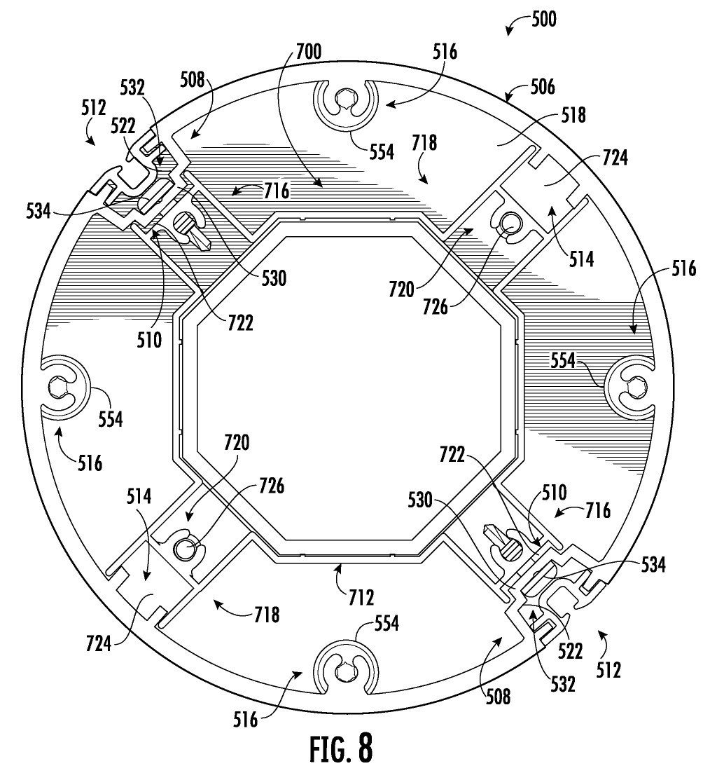

The base walls 522 connect the sidewalls 520 and extend in generally orthogonal (perpendicular) relation thereto such that the sidewalls 520 and the base walls 522 collectively define chambers 526 which receive the keys 512 (FIGS. 8, 9). The base walls 522 are non-linear in configuration and include (define) channels 528 that extend radially inward into the base walls 522 so as to define the alignment members 510 which are configured as shoulders 530.

The channels 528 receive and create clearance for fasteners 532 (e.g., self-tapping screws 534) which, in certain embodiments of the roller tube assembly 100, extend through the base walls 522 and into the drive reel assemblies 700 in order to connect the outer tube 500 and the drive reel assemblies 700. As seen in FIG. 8, upon insertion of the keys 512 into the reliefs 508, the keys 512 overlie the fasteners 532 such that the fasteners 532 are concealed within the outer tube 500 and are hidden from view.

The alignment members 510 extend continuously between the ends 502, 504 of the outer tube 500 and radially inward from the base walls 522 of the reliefs 508 (e.g., into the internal passage 518). The alignment members 510 (e.g., the shoulders 530) and engage (contact) the drive reel assemblies 700 (i.e., the drive reel assembly 700i and the drive reel assembly 700ii), as described in further detail below, in order to facilitate proper alignment and connection of the outer tube 500 and the drive reel assemblies 700 during assembly of the roller tube assembly 100.

In the illustrated embodiment, the outer tube 500 includes a pair of the alignment members 510 (e.g., an alignment member 510i(FIG. 6) and an alignment member 510ii) which are separated by approximately 180 degrees. Embodiments in which the number of the alignment members 510 and/or the positioning thereof may be varied are also envisioned herein, however (e.g., depending upon the size of the roller tube assembly 100, the specific configuration and/or the material used in fabrication of the covering 600, the requirements of the particular installation, etc.).

The teeth 524 (FIG. 7) extend inwardly from the sidewalls 520 and into the chambers 526. More specifically, the teeth 524 extend in generally orthogonal (perpendicular) relation to the sidewalls 520 and in generally parallel relation to the base walls 522. The teeth 524 engage (contact) and extend into the keys 512 (FIGS. 8, 9) in order to connect (secure) the keys 512 to the outer tube 500 within the chambers 526, as described in further detail below.

With reference to FIGS. 8 and 9 in particular, the keys 512 will be discussed.

The keys 512 indirectly connect the covering 600 to the outer tube 500 and are multipurpose (e.g., universal) in configuration which facilitates use of the roller tube assembly 100 with a variety of materials, screens, shades, shutters, etc., thereby increasing the utility and the adaptability of the roller tube assembly 100. The interface between the keys 512 and the outer tube 500 (e.g., positioning of the keys 512 within the reliefs 508 (FIGS. 6, 8)) not only allows force from the covering 600 to be applied to the keys 512 rather than the outer tube 500, thereby reducing stress on the outer tube 500, but facilities manufacturing of the outer tube 500. More specifically, by configuring the reliefs 508 to receive the keys 512, the dimensions of the reliefs 508 can be increased, which reduces manufacturing tolerances and design complexity, thereby increasing the extrudability of the outer tube 500.

The keys 512 may be either removably or fixedly (e.g., non-removably) connected to the outer tube 500 and include bodies 536 defining interior spaces 538 and flanges 540.

The bodies 536 include backspans 542 and arms 544 that extend from the backspans 542 in generally orthogonal (perpendicular) relation thereto such that the bodies 536 include generally U-shaped configurations. The arms 544 include fingers 546 that extend inwardly therefrom (e.g., towards each other) in order to define necks 548. The necks 548 define and narrow the entrances to the interior spaces 538 such that the fingers 546 engage (contact) and secure the covering 600 within the keys 512 (e.g., by biting into the material of the covering 600).

The flanges 540 extend outwardly from the bodies 536 in generally orthogonal (perpendicular) relation to the arms 544 and in generally parallel relation to the fingers 546. The flanges 540 define cavities 550 that receive the teeth 524 (FIG. 7) such that the teeth 524 extend into the cavities 550 to thereby connect (secure) the keys 512 within the reliefs 508 (e.g., the chambers 526).

With reference now to FIGS. 6 and 8, the alignment members 514 extend continuously between the ends 502, 504 of the outer tube 500 and radially inward from the outer wall 506 (e.g., into the internal passage 518). The alignment members 514 include prongs 552 and engage (contact) the drive reel assemblies 700 (i.e., the drive reel assembly 700i and the drive reel assembly 700ii), as described in further detail below, in order to further facilitate proper alignment and connection of the outer tube 500 and the drive reel assemblies 700 during assembly of the roller tube assembly 100. The alignment members 514 also increase the surface area in contact between the outer tube 500 and the drive reel assemblies 700, which not only reinforces the engagement (contact) therebetween but stabilizes the assembly of the motor 300, the idler 400, the outer tube 500, and the drive reel assemblies 700 in order to inhibit (e.g., prevent) deflection or relative movement between the components. Embodiments of the roller tube assembly 100 that are devoid of the alignment members 514 are also envisioned herein, however (depending upon the size of the roller tube assembly 100, the specific configuration and/or the material used in fabrication of the covering 600, the requirements of the particular installation, etc.).

In the illustrated embodiment, the outer tube 500 includes a pair of the alignment members 514 (e.g., an alignment member 514i and an alignment member 514ii) which are separated by approximately 180 degrees. More specifically, the outer tube 500 is configured such that the alignment member 510i, the alignment member 514i, the alignment member 510ii, and the alignment member 514ii are arranged in an alternating pattern such that the alignment member 514i and the alignment member 514ii are positioned between the alignment member 510i and the alignment member 510ii. Embodiments in which the number of the alignment members 514 and/or the positioning thereof may be varied are also envisioned herein, however (e.g., depending upon the size of the roller tube assembly 100, the specific configuration and/or the material used in fabrication of the covering 600, the requirements of the particular installation, etc.).

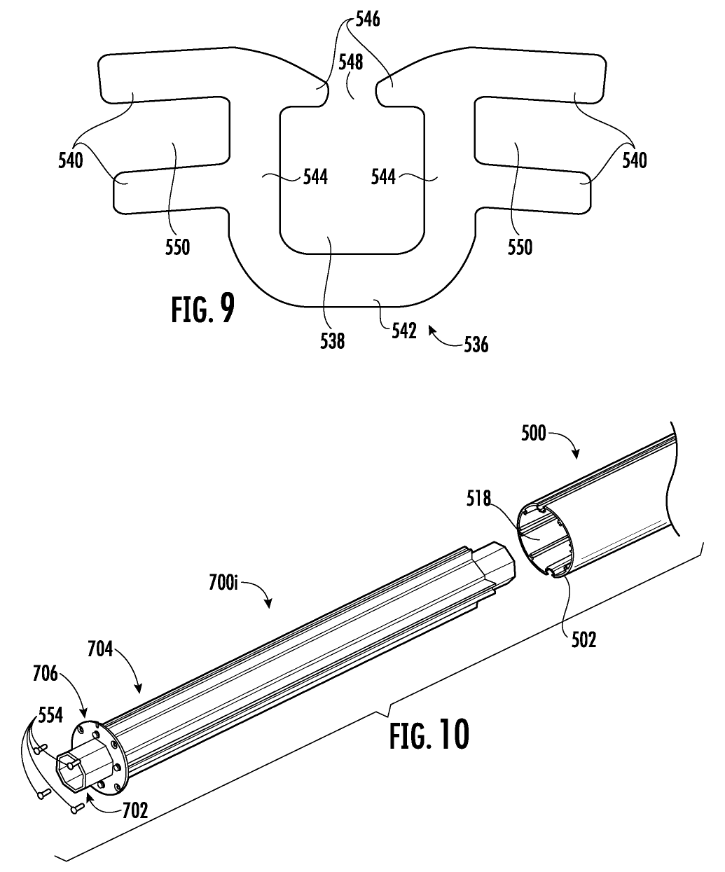

With continued reference to FIGS. 6 and 8, the flutes 516 extend from the end 502 to the end 504 of the outer tube 500 and receive fasteners 554 (FIGS. 8, 10). The fasteners 554 are oriented in generally orthogonal (perpendicular) relation to the fasteners 532 and further facilitate connection of the outer tube 500 and the drive reel assemblies 700, as described in further detail below.

In the illustrated embodiment, the outer tube 500 includes four flutes 516. More specifically, the outer tube includes: a flute 516i (which may be referred to as a first flute); a flute 516ii (which may be referred to as a second flute); a flute 516iii(which may be referred to as a third flute); and a flute 516iv (which may be referred to as a fourth flute) which are separated by approximately 90 degrees. Embodiments in which the number of flutes 516 and/or the positioning thereof may be varied are also envisioned herein, however (e.g., depending upon the size of the roller tube assembly 100, the specific configuration and/or the material used in fabrication of the covering 600, the requirements of the particular installation, etc.).

With reference now to FIGS. 10-14 in particular, the drive reel assemblies 700 will be discussed.

The drive reel assemblies 700 are generally identical in configuration and extend into the outer tube 500 such that the outer tube 500 receives and (partially) covers (conceals) the drive reel assemblies 700. More specifically, the drive reel assembly 700i extends into the end 502 of the outer tube 500, and the drive reel assembly 700ii extends into the end 504 of the outer tube 500. The drive reel assemblies 700 transfer power from the motor 300 to the outer tube 500 in order to facilitate rotation thereof and, thus, extension and retraction of the covering 600.

The drive reel assemblies 700 define lengths L2 (FIG. 11) (which may be referred to as second lengths) that are less than the length L1 (FIG. 3) and include: drive tubes 702; drive reels 704; and mounting plates 706.

In the illustrated embodiment, the drive reel assemblies 700 are configured such that the lengths L2 lie substantially within the range of approximately two feet to approximately four feet (e.g., approximately three feet). Embodiments in which the drive reel assemblies 700 are configured such that the lengths L2 lie outside the disclosed range are also envisioned herein, however (e.g., depending upon the size of the roller tube assembly 100, the specific configuration and/or the material used in fabrication of the covering 600, the requirements of the particular installation, etc.).

The drive tubes 702 include a metallic material (e.g., aluminum) and, in the illustrated embodiment, are formed via extrusion. Alternate materials of construction and alternate methods of manufacturing the drive tubes 702 are also envisioned herein, however (e.g., depending upon the size of the roller tube assembly 100, the specific configuration and/or the material used in fabrication of the covering 600, the requirements of the particular installation, etc.).

The drive tubes 702 define the lengths L2 and interface with the motor 300 and the idler 400 in order to connect the drive reel assemblies 700 thereto such rotation of the motor 300 causes corresponding rotation of the drive tubes 702 and, thus, the drive reel assemblies 700, the outer tube 500, and the idler 400. More specifically, the drive tube 702 on the drive reel assembly 700i interfaces with the motor 300, and the drive tube 702 on the drive reel assembly 700ii interfaces with the idler 400.

The drive tubes 702 are hollow in construction which reduces the overall weight of the roller tube assembly 100 and define non-circular (e.g., octagonal) transverse cross-sectional configurations. The non-circular transverse cross-sectional configurations of the drive tubes 702 facilitate engagement (contact) with the motor 300 and the idler 400 as well as with the drive reels 704 so as to inhibit relative rotation therebetween, thereby creating mechanical interfaces between the drive tubes 702 and the motor 300, the idler 400, and the drive reels 704.

The drive reels 704 include a metallic material (e.g., aluminum) and, in the illustrated embodiment, are formed via extrusion. Alternate materials of construction and alternate methods of manufacturing the drive reels 704 are also envisioned herein, however (e.g., depending upon the size of the roller tube assembly 100, the specific configuration and/or the material used in fabrication of the covering 600, the requirements of the particular installation, etc.).

The drive reels 704 provide an interface between the drive reel assemblies 700 and the outer tube 500 such that rotation of the drive reel assemblies 700 causes corresponding rotation of the outer tube 500. The drive reels 704 receive the drive tubes 702 such that the drive tubes 702 extend into the drive reels 704, as described in further detail below.

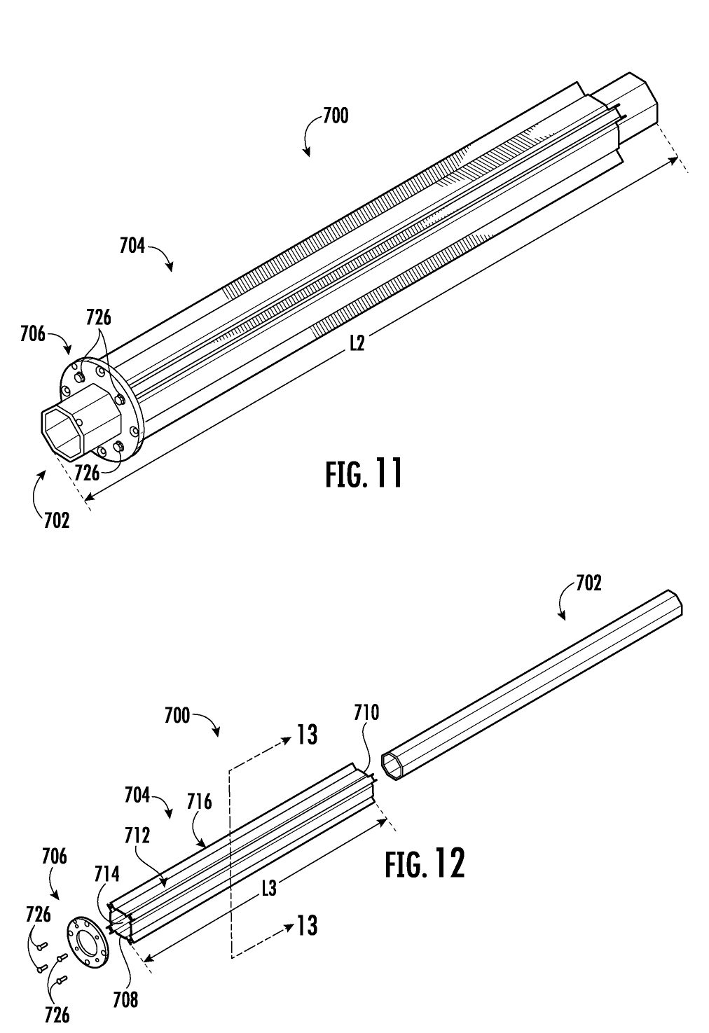

The drive reels 704 define lengths L3 (FIG. 12) (which may be referred to as third lengths) which are less than the lengths L2 defined by the drive tubes 702. The reduced lengths of the drive reels 704 (e.g., in relation to the drive tubes 702) allows the drive tubes 702 to extend beyond the drive reels 704, which allows the orientations of the drive reel assemblies 700 to be reversed in certain embodiments of the disclosure, as described in further detail below.

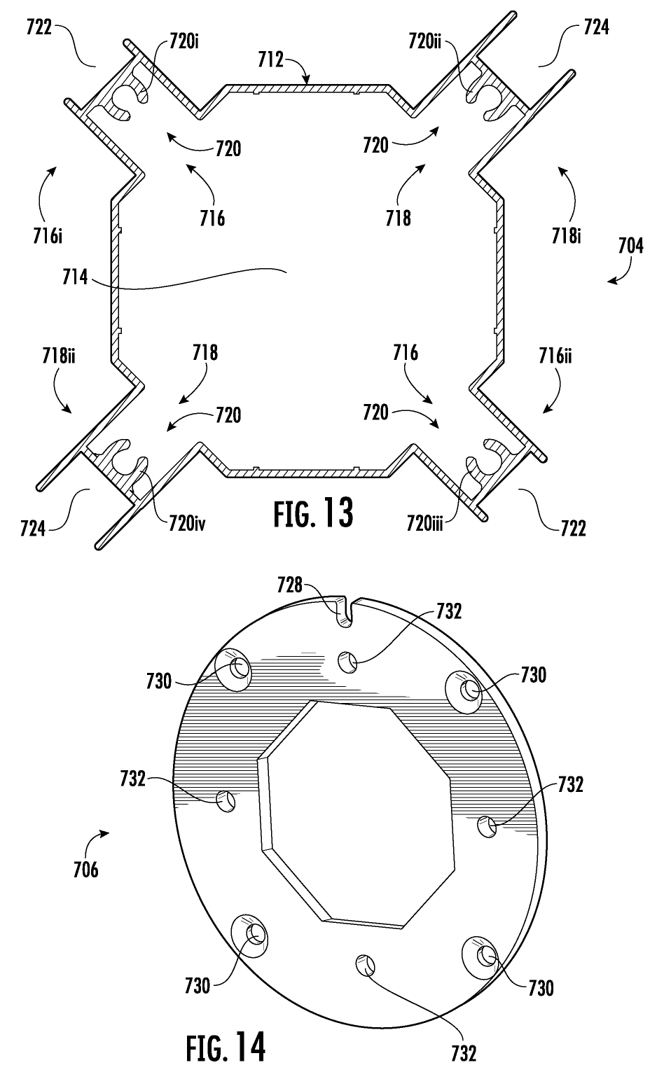

The drive reels 704 include: ends 708 (which may be referred to as first ends); ends 710 (which may be referred to as second ends); outer walls 712 defining internal passages 714; alignment members 716 (which may be referred to as third alignment members); alignment members 718 (which may be referred to as fourth alignment members); and flutes 720 (FIGS. 8, 13).

The internal passages 714 receive the drive tubes 702 such that the drive tubes 702 are exposed from and extend beyond the ends 708, 710 of the drive reels 704 by approximately equivalent distances, as seen in FIG. 11. The internal passages 714 and the drive tubes 702 define corresponding non-circular (e.g., octagonal) transverse cross-sectional configurations such that rotation of the drive tubes 702 (e.g., via the motor 300) causes corresponding rotation of the drive reels 704 and, thus, the outer tube 500.

In certain embodiments, in order to further facilitate concomitant rotation of the drive tubes 702 and the drive reels 704, it is envisioned that the drive tubes 702 and the drive reels 704 may be fixedly connected (e.g., via welding).

The alignment members 716 extend radially outward from the outer walls 712 and engage (contact) the alignment members 510 (FIG. 8) on the outer tube 500 in order to facilitate proper alignment and connection of the outer tube 500 and the drive reel assemblies 700 during assembly of the roller tube assembly 100, as indicated above. More specifically, the alignment members 716 define channels 722 that receive the alignment members 510 (e.g., the shoulders 530) such that the alignment members 510 extend into the channels 722.

In the illustrated embodiment, the drive reels 704 include a pair of the alignment members 716 (e.g., an alignment member 716i(FIG. 13) and an alignment member 716ii) which are separated by approximately 180 degrees such that the alignment members 510 and the alignment members 716 correspond in both number and position. Embodiments in which the number of the alignment members 716 and/or the positioning thereof may be varied are also envisioned herein, however (e.g., depending upon the size of the roller tube assembly 100, the specific configuration and/or the material used in fabrication of the covering 600, the requirements of the particular installation, etc.).

The alignment members 718 extend radially outward from the outer walls 712 and engage (contact) the alignment members 514 on the outer tube 500 in order to further facilitate proper alignment and connection of the outer tube 500 and the drive reel assemblies 700 during assembly of the roller tube assembly 100 as well as increase the surface area in contact between the outer tube 500 and the drive reel assemblies 700, as indicated above. More specifically, the alignment members 718 define channels 724 that receive the alignment members 514 (e.g., the prongs 552) such that the alignment members 514 extend into the channels 724.

In the illustrated embodiment, the drive reels 704 include a pair of the alignment members 718 (e.g., an alignment member 718i and an alignment member 718ii) which are also separated by approximately 180 degrees such that the alignment members 514 and the alignment members 718 correspond in both number and position. More specifically, the drive reels 704 are configured such that the alignment member 716i, the alignment member 718i, the alignment member 716ii, and the alignment member 718ii are arranged in an alternating pattern such that the alignment member 718i and the alignment member 718ii are positioned between the alignment member 716i and the alignment member 716ii. Embodiments in which the number of alignment members 718 and/or the positioning thereof may be varied are also envisioned herein, however (e.g., depending upon the size of the roller tube assembly 100, the specific configuration and/or the material used in fabrication of the covering 600, the requirements of the particular installation, etc.).

The flutes 720 are supported by (included on) the alignment members 716 and the alignment members 718 and receive fasteners 726 (FIGS. 8, 11, 12). The fasteners 726 are oriented in generally orthogonal (perpendicular) relation to the fasteners 532 and in generally parallel relation to the fasteners 554 (FIGS. 8, 10) and facilitate connection of the drive reels 704 and the mounting plates 706, as described in further detail below.

In the illustrated embodiment, the drive reels 704 includes four flutes 720 which are separated by approximately 90 degrees. More specifically, the drive reels 704 include: flutes 720i (which may be referred to as first flutes); flutes 720ii (which may be referred to as second flutes); flutes 720iii (which may be referred to as third flutes); and flutes 720iv (which may be referred to as fourth flutes). Embodiments in which the number of flutes 720 and/or the positioning thereof may be varied are also envisioned herein, however (e.g., depending upon the size of the roller tube assembly 100, the specific configuration and/or the material used in fabrication of the covering 600, the requirements of the particular installation, etc.).

With reference now to FIGS. 10-12 and 14 in particular, the mounting plates 706 will be discussed.

The mounting plates 706 include a metallic material (e.g., aluminum) and, in the illustrated embodiment, are formed via stamping, laser machining, or any other suitable method of manufacture. Alternate materials of construction and alternate methods of manufacturing the mounting plates 706 are also envisioned herein, however (e.g., depending upon the size of the roller tube assembly 100, the specific configuration and/or the material used in fabrication of the covering 600, the requirements of the particular installation, etc.).

The mounting plates 706 are connected (secured) to the ends 708 of the drive reels 704 and to the ends 502, 504 of the outer tube 500, as described in further detail below, thereby closing off the outer tube 500. The mounting plates 706 include: channels 728 (FIG. 14); apertures 730 (which may be referred to as first apertures or outer apertures); and apertures 732 (which may be referred to as second apertures or inner apertures).

The channels 728 are configured to receive sections of the covering 600 that extend axially beyond the ends 502, 504 of the outer tube 500 (e.g., along the length L1 (FIG. 3)). Configuring the drive reel assemblies 700 such that the covering 600 extends beyond the outer tube 500 not only allows the covering 600 to obscure the ends 708 of the drive tubes 702 and the mounting plates 706, thereby hiding the drive tubes 702, the mounting plates 706, the fasteners 554, and the fasteners 726 from view, but creates additional clearance for the covering 600 during retraction so as not to interfere with the operation of the roller tube assembly 100.

The apertures 730 receive the fasteners 554 (FIGS. 8, 10) such that the fasteners 554 extend through the mounting plate 706 and into the flutes 516 (FIGS. 6, 8) in the outer tube 500 to thereby connect the drive reel assemblies 700 (e.g., the mounting plates 706) to the ends 502, 504 of the outer tube 500.

The apertures 732 receive the fasteners 726 (FIGS. 8, 11, 12) such that the fasteners 726 extend through the mounting plate 706 and into the flutes 720 (FIGS. 8, 13) in the drive reels 704 to thereby connect the mounting plates 706 to the drive reels 704, as indicated above.

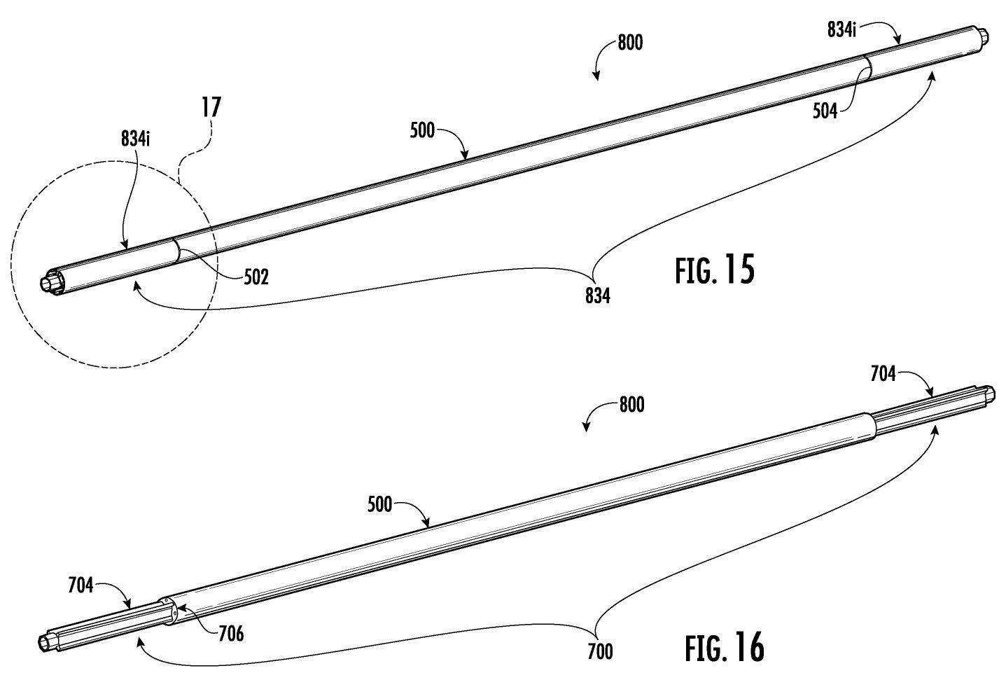

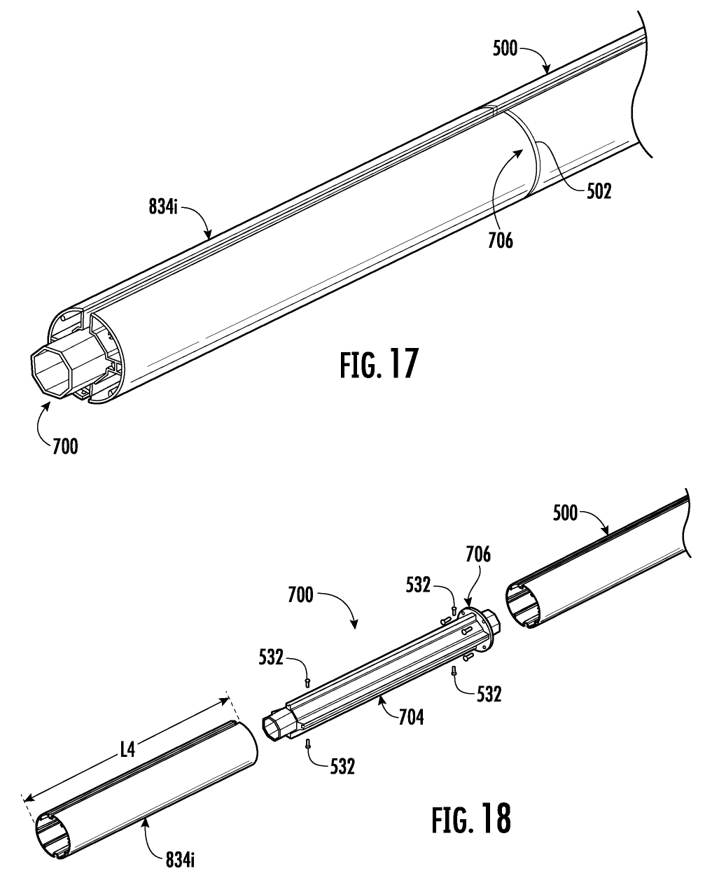

With reference now to FIGS. 15-18, a roller tube assembly 800 will be discussed which is an alternate embodiment of the roller tube assembly 100. The roller tube assembly 100 and the roller tube assembly 800 are substantially in both structure and function and, accordingly, will only be discussed with respect to certain differences therebetween in the interest of brevity. As such, identical reference characters will be utilized to refer to elements, structures, features, etc., common to the roller tube assembly 100 and the roller tube assembly 800.

The roller tube assembly 800 is configured and intended for use in an installation in which the length L1 (FIG. 3) of the outer tube 500 is insufficient to span the window or the door W (FIG. 2). In order to accommodate the additional length requirement, in addition to the outer tube 500 and the drive reel assemblies 700, the roller tube assembly 800 (e.g., the outer tube 500) includes extensions 834 that are positioned (located) adjacent to ends 502, 504 of the outer tube 500.

In the illustrated embodiment, the roller tube assembly 800 includes an extension 834i (which may be referred to as a first extension) that is positioned (located) adjacent to the end 502 of the outer tube 500, and an extension 834ii (which may be referred to as a second extension) that is positioned (located) adjacent to the end 504 of the outer tube 500.

The extensions 834 are identical in configuration to the outer tube 500 other than the lengths thereof and are connected (secured) to the drive reel assemblies 700 via the fasteners 532 (FIGS. 8, 18) which extend through the extensions 834 and into the drive reels 704. More specifically, in the illustrated embodiment, the extensions 834 define lengths L4, which are less than the lengths L2 of the drive reel assemblies 700 such that the drive reel assemblies 700 protrude from the extensions 834 in order to enable engagement with (connection to) the motor 300 (FIG. 2) and the idler 400. It is envisioned, however, that the extensions 834 may be fabricated to achieve any necessary or desired lengths L4 (e.g., depending upon the size of the roller tube assembly 100, the specific configuration and/or the material used in fabrication of the covering 600, the requirements of the particular installation, etc.) which allows for the utilization of scrap material for the outer tube 500.

As can be appreciated through reference to FIGS. 3, 15, and 16, the orientations of the drive reel assemblies 700 are reversed in the roller tube assembly 100 and the roller tube assembly 800. More specifically, whereas in the roller tube assembly 100, the drive reel assemblies 700 are oriented such that the mounting plates 706 face outwardly and are exposed from the ends 502, 504 of the outer tube 500, in the roller tube assembly 800, the drive reel assemblies 700 are oriented such that the mounting plates 706 face inwardly and are positioned (located) between the extensions 834 and the ends 502, 504 of the outer tube 500.

In one aspect of the present disclosure, a roller tube assembly for use with a window or a door is disclosed that is configured to raise and lower a covering. The roller tube assembly includes: a mounting member that is configured for connection to a mounting surface on or about the window or the door and which includes a first end and a second end; a motor that is supported by the mounting member at the first end thereof; an idler that is supported by the mounting member at the second end thereof; a first drive reel assembly that engages the motor such that actuation of the motor causes rotation of the first drive reel assembly; a second drive reel assembly that engages the idler; and an outer tube that receives and is connected to the first drive reel assembly and the second drive reel assembly such that rotation of the first drive reel assembly causes corresponding rotation of the outer tube, the second drive reel assembly, and the idler.

The outer tube includes: a first end that receives the first drive reel assembly; a second end that receives the second drive reel assembly; and an outer wall that defines a single internal passage which extends between the first end of the outer tube and the second end of the outer tube.

The covering is connected to the outer tube such that rotation of the outer tube in a first direction causes extension of the covering to cover the window or the door and rotation of the outer tube in a second direction causes retraction of the covering to expose the window or the door.

In certain embodiments, the outer wall may extend continuously about a circumference of the outer tube.

In certain embodiments, the outer tube may be connected to the first drive reel assembly and the second drive reel assembly by fasteners that are concealed within the outer tube such that the fasteners are hidden from view.

In certain embodiments, the outer tube may include reliefs that extend inwardly into the internal passage.

In certain embodiments, the reliefs may be configured to receive keys that connect the covering to the outer tube.

In certain embodiments, the fasteners may extend through base walls of the reliefs and into the first drive reel assembly and the second drive reel assembly such that, upon positioning of the keys within the reliefs, the keys conceal the fasteners.

In certain embodiments, the reliefs may include first alignment members that engage the first drive reel assembly and the second drive reel assembly.

In certain embodiments, the first alignment members may extend radially inward from the base walls of the reliefs.

In certain embodiments, the outer tube may include second alignment members that extend radially inward from the outer wall and engaging the first drive reel assembly and the second drive reel assembly.

In certain embodiments, the first alignment members and the second alignment members may be arranged in an alternating pattern.

In another aspect of the present disclosure, a roller tube assembly for use with a window or a door is disclosed that is configured to raise and lower a covering. The roller tube assembly includes an outer tube and drive reel assemblies.

The outer tube includes an outer wall that defines a single internal passage which extends between opposite ends of the outer tube.

The drive reel assemblies extend into the opposite ends of the outer tube, and the outer tube is connected to the drive reel assemblies such that the outer tube and the drive reel assemblies rotate in unison.

In certain embodiments, the outer wall may extend continuously about a circumference of the outer tube.

In certain embodiments, the roller tube assembly may further include fasteners that extend through the outer tube and into the drive reel assemblies to connect the outer tube and the drive reel assemblies.

In certain embodiments, the fasteners may be concealed within the outer tube such that the fasteners are hidden from view.

In certain embodiments, the outer tube may include reliefs that extend inwardly into the internal passage.

In certain embodiments, the reliefs may be configured to receive keys that connect a covering to the outer tube such that the keys overlie the fasteners to thereby conceal the fasteners within the outer tube.

In another aspect of the present disclosure, a roller tube assembly for use with a window or a door is disclosed that is configured to raise and lower a covering .The roller tube assembly includes an outer tube that defines an internal passage and drive reel assemblies that extend into the internal passage.

The drive reel assemblies include: drive tubes; drive reels that receive the drive tubes and engage the outer tube such that rotation of the drive reel assemblies causes corresponding rotation of the outer tube; and mounting plates that are connected to the drive reels.

In certain embodiments, the outer tube may include first alignment members that extend radially inward into the internal passage.

In certain embodiments, the drive reels may include outer walls and second alignment members that extend radially outward from the outer walls and which engage the first alignment members.

In certain embodiments, the outer tube may further include third alignment members that extend radially inward into the internal passage.

In certain embodiments, the drive reels may include fourth alignment members that extend radially outward from the outer walls and which engage the third alignment members.

In certain embodiments, the drive tubes and the drive reels may include corresponding non-annular cross-sectional configurations such that rotation of the drive tubes causes corresponding rotation of the drive reels and the outer tube.

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims which is to be accorded the broadest interpretation to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternate embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180° ± 25% (i.e., an angle that lies within the range of (approximately) 135° to (approximately) 225°) and the term “generally orthogonal” should be understood as referring to configurations in with the pertinent components are oriented so as to define an angle therebetween that is equal to 90° ± 25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A roller tube assembly for use with a window or a door and configured to raise and lower a covering, the roller tube assembly comprising:
a mounting member configured for connection to a mounting surface on or about the window or the door, wherein the mounting member includes a first end and a second end;
a motor supported by the mounting member at the first end thereof;
an idler supported by the mounting member at the second end thereof;
a first drive reel assembly engaging the motor such that actuation of the motor causes rotation of the first drive reel assembly;
a second drive reel assembly engaging the idler; and
an outer tube receiving and connected to the first drive reel assembly and the second drive reel assembly such that rotation of the first drive reel assembly causes corresponding rotation of the outer tube, the second drive reel assembly, and the idler, wherein the outer tube includes:
a first end receiving the first drive reel assembly;
a second end receiving the second drive reel assembly; and
an outer wall defining a single internal passage extending between the first end of the outer tube and the second end of the outer tube, wherein the covering is connected to the outer tube such that rotation of the outer tube in a first direction causes extension of the covering to cover the window or the door and rotation of the outer tube in a second direction causes retraction of the covering to expose the window or the door.

2. The roller tube assembly of claim 1, wherein the outer wall extends continuously about a circumference of the outer tube.

3. The roller tube assembly of claim 1, wherein the outer tube is connected to the first drive reel assembly and the second drive reel assembly by fasteners concealed within the outer tube such that the fasteners are hidden from view.

4. The roller tube assembly of claim 3, wherein the outer tube includes reliefs extending inwardly into the internal passage.

5. The roller tube assembly of claim 4, wherein the reliefs are configured to receive keys that connect the covering to the outer tube.

6. The roller tube assembly of claim 5, wherein the fasteners extend through base walls of the reliefs and into the first drive reel assembly and the second drive reel assembly such that, upon positioning of the keys within the reliefs, the keys conceal the fasteners.

7. The roller tube assembly of claim 6, wherein the reliefs include first alignment members engaging the first drive reel assembly and the second drive reel assembly.

8. The roller tube assembly of claim 7, wherein the first alignment members extend radially inward from the base walls of the reliefs.

9. The roller tube assembly of claim 8, wherein the outer tube includes second alignment members extending radially inward from the outer wall and engaging the first drive reel assembly and the second drive reel assembly.

10. The roller tube assembly of claim 9, wherein the first alignment members and the second alignment members are arranged in an alternating pattern.

11. A roller tube assembly for use with a window or a door and configured to raise and lower a covering, the roller tube assembly comprising:
an outer tube including an outer wall defining a single internal passage extending between opposite ends of the outer tube; and
drive reel assemblies extending into the opposite ends of the outer tube, wherein the outer tube is connected to the drive reel assemblies such that the outer tube and the drive reel assemblies rotate in unison.

12. The roller tube assembly of claim 11, wherein the outer wall extends continuously about a circumference of the outer tube.

13. The roller tube assembly of claim 11, further comprising:
fasteners extending through the outer tube and into the drive reel assemblies to connect the outer tube and the drive reel assemblies.

14. The roller tube assembly of claim 13, wherein the fasteners are concealed within the outer tube such that the fasteners are hidden from view.

15. The roller tube assembly of claim 14, wherein the outer tube includes reliefs extending inwardly into the internal passage and configured to receive keys that connect a covering to the outer tube such that the keys overlie the fasteners to conceal the fasteners within the outer tube.

16. A roller tube assembly for use with a window or a door and configured to raise and lower a covering, the roller tube assembly comprising:
an outer tube defining an internal passage; and
drive reel assemblies extending into the internal passage, wherein the drive reel assemblies include:
drive tubes;
drive reels receiving the drive tubes and engaging the outer tube such that rotation of the drive reel assemblies causes corresponding rotation of the outer tube; and
mounting plates connected to the drive reels.

17. The roller tube assembly of claim 16, wherein the outer tube includes first alignment members extending radially inward into the internal passage.

18. The roller tube assembly of claim 17, wherein the drive reels include:
outer walls; and
second alignment members extending radially outward from the outer walls and engaging the first alignment members.

19. The roller tube assembly of claim 18, wherein the outer tube further includes third alignment members extending radially inward into the internal passage, and the drive reels further include fourth alignment members extending radially outward from the outer walls and engaging the third alignment members.

20. The roller tube assembly of claim 16, wherein the drive tubes and the drive reels include corresponding non-annular cross-sectional configurations such that rotation of the drive tubes causes corresponding rotation of the drive reels and the outer tube.
